(19) United States
(12) Patent Application Publication
(10) Pub. No.: US 2011/0192690 A1
(43) Pub. Date: Aug. 11, 2011

(54) ARRESTING ASSEMBLY FOR A SUITCASE

(76) Inventor: HANHUI JIANG, DONGGUAN CITY (CN)

(21) Appl. No.: 12/823,384

(22) Filed: Jun. 25, 2010

(30) Foreign Application Priority Data
Feb. 10, 2010 (CN) 201020117375.3

(51) Int. Cl. B62B 5/04; B60T 7/08; A45C 5/14

(52) U.S. Cl. 190/18 A; 188/31

(57) ABSTRACT

An arresting assembly for a suitcase comprises: an arresting device; and a driving device, the driving device comprising: a press and pull assembly comprising a housing and a press subassembly; a transmission and buckle assembly comprising a connection casing, a buckle element and a spring both mounted in the connection casing, with the spring being between the buckle element and an inner wall of the connection casing, and the buckle element being connected with the arresting device; and a pulling rope comprising a rope core and an elastic sleeve, the rope core being longer than the elastic sleeve in length, both ends of the rope core being respectively connected to an inner wall of the housing and the buckle element, both ends of the elastic sleeve being respectively connected to the press subassembly and the connection casing. The arresting assembly is simple in structure and easy for arresting.

### BACKGROUND OF THE INVENTION

The present invention relates to a suitcase, and in particular to an arresting assembly for a suitcase.

Normally, a suitcase has wheels in order to facilitate transportation. The wheels of the suitcase in the prior art can freely roll forwards, and it would happen that the suitcase on the car will glide forwards due to inertia when a car that a traveler take for traveling is braked, and this more or less brings inconvenience for the traveler in use.

In some suitcases which have arresting function, the arresting assembly is very complicated in structure, for example, in some cases, the arresting is actuated by the pulling rod, while a spanner is used for arresting in some suitcases.

In conclusion, the known arresting assembly is complicated in structure, laborious for arresting and unsuitable for daily use.

### SUMMARY OF THE INVENTION

Having outlined the state of the prior art and its attendant shortcomings, it is an object of the present invention to provide an arresting assembly for a suitcase, which is simple in structure and easy for arresting.

The above object is achieved by the following technical solution:

An arresting assembly for a suitcase, comprises: an arresting device connected to a wheel of the suitcase; and a driving device connected to the arresting device, the driving device comprising: a press and pull assembly comprising a housing and a press subassembly; a transmission and buckle assembly comprising a connection casing, a buckle element and a spring both mounted in the connection casing, with the spring being between the buckle element and an inner wall of the connection casing, and the buckle element being connected with the arresting device; and a pulling rope comprising a rope core and an elastic sleeve slidably covering around the rope core, the rope core is longer than the elastic sleeve in length, both ends of the rope core being respectively connected to an inner wall of the housing and the buckle element, both ends of the elastic sleeve being respectively connected to the press subassembly and the connection casing.

Preferably, the arresting device comprises a driving lever, a connection element and an arresting element, two ends of the driving lever are connected with the connection element and the arresting element respectively, and the driving lever is connected to the buckle element via the connection element.

Preferably, the wheel is a single wheel, the arresting element is a U-shaped member, the U-shaped member has an opening larger than the wheel in width, and a pair of arresting pins towards each other is arranged at the inner wall of the opening.

Alternatively, the wheel may be a double wheel, the arresting element is a U-shaped member, the U-shaped member has an opening with an outer wall on which a pair of arresting pins is mounted oppositely.

Preferably, the arresting pin has a threaded end for being connected with a corresponding threaded hole on the arresting element.

Alternatively, the arresting pin is riveted to the arresting element.

Preferably, both ends of the rope core are provided with a clamping head, and a clamping slot for cooperating with the clamping head is provided on the inner wall of the housing and on the buckle element.

Preferably, both ends of the elastic sleeve are provided with an end tightening casing.

It is a further object for the present invention to provide a suitcase, comprising: a suitcase body; a pull rod having an outer pipe and mounted on a rear side of the suitcase body;

and the arresting assembly as described above; wherein the driving device is mounted in the outer pipe and leans against components in the outer pipe, and the arresting device and the wheel are cooperatively mounted on the suitcase body.

The advantages of the present invention lie in that: by way of the pressing on the press element of the driving device, the pressure is transmitted by the press and pull assembly to the elastic sleeve, and because an end of the rope core is fixed to the housing, the elastic sleeve is slid with respect to the rope core such that the elastic sleeve is pressed, and the other end of the elastic sleeve is connected to the fixed connection casing, therefore the elastic sleeve is bended towards one side, and the buckle element connected to the other end of the rope core is thus pulled such that the buckle element overcoming the spring force of the spring is moved towards a direction opposite to the pressing direction of the press element, until the arresting device is pulled. The driving structure is simple and labor saving in arresting.

### BRIEF DESCRIPTION OF THE DRAWINGS

FIG. 1 is a schematic perspective view of an arresting assembly for a suitcase according to an embodiment of the present invention;

FIG. 2 is a schematic view of the driving device;

FIG. 3 is a schematic view of the press subassembly;

FIG. 4 is a schematic view showing the connection relationship between the arresting device and the buckle element;

FIG. 5 is a schematic view of the arresting of a single wheel;

FIG. 6 is a schematic view of the arresting of a double wheel;

FIG. 7 is an exploded view of the arresting components used in the double wheel.

Wherein:

100 driving device;

110 press and pull assembly;

112 housing; 114 press subassembly; 116 clamping slot;

114a press element; 114b buffer spring; 114c sliding element

120 pulling rope;

122 rope core; 124 elastic sleeve; 126 clamping head; 128 end tightening casing;

130 transmission and buckle assembly;

132 connection casing; 134 spring; 136 buckle element; 136a opening;

200 arresting device;

210 driving lever; 212 clamping slot

220 connection element; 222 opening;

230 arresting element; 232 arresting pin;

300 wheel assembly;

310 bracket;

320 wheel; 322 tooth recess;

400 return assembly;

410 connection seat; 420 return spring; 430 retaining element;

440 position limiting piece; 450 position limiting nut.

### DETAILED DESCRIPTION OF THE PREFERRED EMBODIMENT

Many aspects of the present invention will be described in detail with reference to the accompanying drawings.

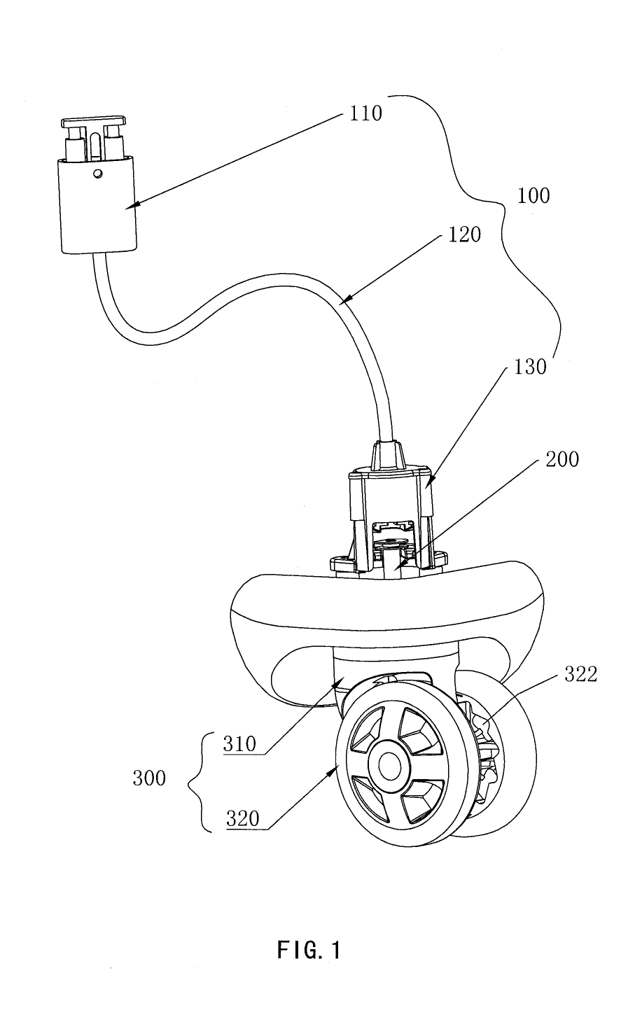

Referring to FIG. 1, an arresting assembly for a suitcase according to an embodiment an arresting assembly for a suitcase according to an embodiment of the present invention is shown. The arresting assembly comprises a driving device 100 and an arresting device 200. The driving device 100 enables the arresting device 200 to stop the wheel assembly 300 from rotation. The wheel assembly 300 comprises a bracket 310 and a wheel 320 connected to the bracket 310. The wheel 320 is provided with tooth recesses 322 which are evenly arranged on the inner circumference and adapted to cooperate with the arresting element 230 as also shown in FIG. 4.

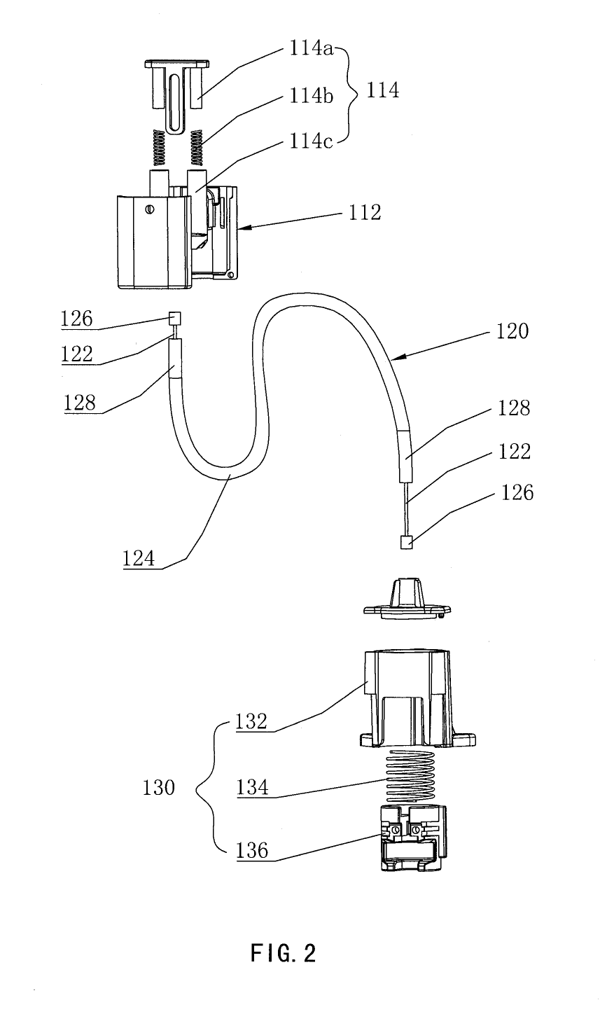

Referring to FIG. 2, the driving device 100 is shown. The driving device 100 comprises a press and pull assembly 110, a pulling rope 120, and a transmission and buckle assembly 130. The press and pull assembly 100 comprises a housing 112 and a press subassembly 114.

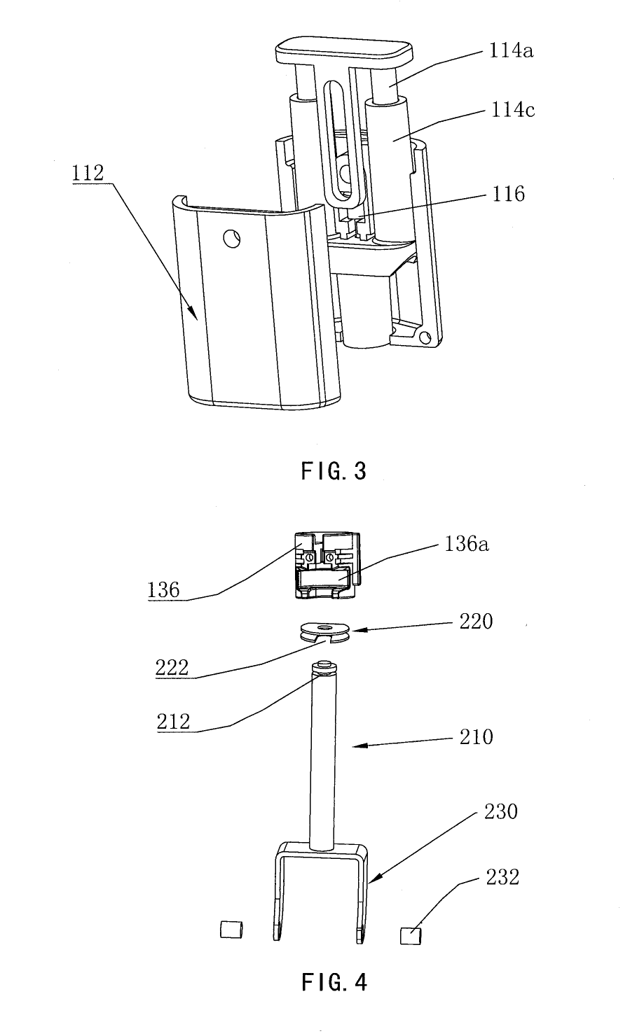

The housing 112 comprises two half-housings connected to each other, and one of the half-housings is provided with a clamping slot 116 as shown in FIG. 3. The press subassembly 114 comprises a press element 114 a, a buffer spring 114b, and a sliding element 114c. Upon pressing, the press element 114a forces the sliding element 114c to glide within the housing 112. The buffer spring 114b is used for buffering the force of the arresting pin 232 applied on the tooth recess 322 such that it is protected when an accidental impact is exerted on the arresting element 230.

The pulling rope 120 comprises a rope core 122 and an elastic sleeve 124 covering around the rope core and adapted to glide with respect to the rope core, the rope core 122 is longer than the elastic sleeve 124 in length.

Referring to FIG. 3, both ends of the rope core 122 are provided with a clamping head 126, the clamping head 126 is cooperated with the clamping slot 116 on one end of the rope core 122, and fixed or moved along with the housing 112.

The elastic sleeve 124 may be made of flexible hard plastic material, and when its two ends are pressed, it will bend towards one side. The elastic sleeve 124 is provided with an end tightening casing 128 at both ends, and the end tightening casing is normally metallic and adapted to reinforce the two ends of the elastic sleeve 124, so that it is convenient for connecting with the press and pull assembly 110 and the transmission and buckle assembly 130, and will prevent the rope core 122 from slipping out of place.

The transmission and buckle assembly 130 comprises a connection casing 132, a buckle element 136 and a spring 134 both mounted in the connection casing 132. The buckle element 136 is provided with a clamping slot 116 similar to that on the inner wall of the housing 112.

The two ends of the rope core 122 are connected to the inner wall of the housing 112 and the buckle element 136 through the clamping slots 116 respectively. The two ends of the elastic sleeve 124 are connected to the sliding element 114c and the connection casing 132. The spring 134 and the buckle element 136 are mounted in the connection casing 132, and the spring 134 is located between the inner wall of the connection casing 132 and the buckle element 136.

Referring to FIG. 4, the arresting device 200 comprises a driving lever 210, a connection element 220 and an arresting element 230. The connection element 220 connects one end of the driving lever 210 to the buckle element 136. In this embodiment, the buckle element 136 has an opening 136a on its sidewall, the connection element 220 is a component having an opening 222. The driving lever 210 has a clamping slot 212 on its end for cooperating with the opening 222 and then inserting into the opening 136a of the buckle element 136 to connect the buckle element 136 with the driving lever 210. In another embodiment, the driving lever 210 is connected to the connection element 220 by way of threaded connection.

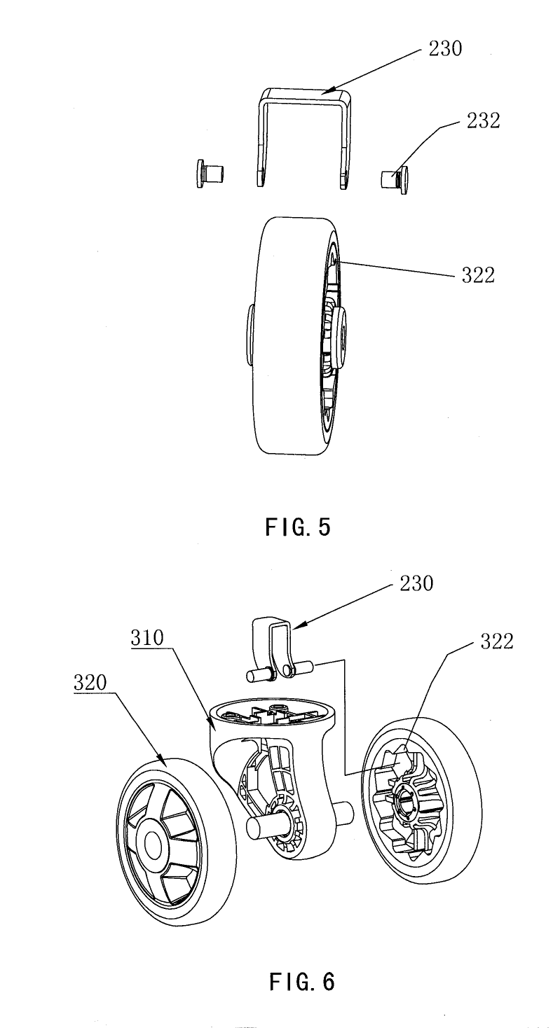

Referring to FIG. 5, the arresting element 230 is a U-shaped member, and provided with a pair of arresting pins 232 towards each other at the inner wall of the opening. The arresting element 230 can be used for arresting a single wheel or a double wheel, and in this embodiment as shown in FIG. 5, it is illustrated for arresting a single wheel. The opening of the U-shaped member has an opening with a width larger than the axial width of the wheel, so that two sides of the opening of the U shape are located at the two sides of the single wheel. The arresting pin 232 is set on the inner wall near the opening and adapted for cooperating with the tooth recess 322.

The arresting pin 232 may be connected to the two sides of the opening of the U shape via various means such as threaded connection and riveted connection. In this embodiment, the threaded connection is adopted, the end of the arresting pin 232 connected to the sidewall of the opening of the U shape has a thread, and the longitudinal width of the thread is identical to or slightly larger than the thickness of the sidewall. For easier mounting, a nut may be further provided on the end.

In another embodiment, the arresting pin 232 is riveted into the sidewall of the opening of the U shape.

It is convenient for mounting the arresting pin 232 for the arresting of the single wheel because the arresting pin 232 is mounted at a post stage.

In another embodiment, it can be used in the arresting of a double wheel. As shown in FIG. 6, a pair of arresting pins is mounted oppositely on the outer wall of the opening of the U shape member such that it can be used for double wheel arresting.

The operation principle of the suitcase arresting assembly of the present embodiment will be described hereinafter.

When in use, the housing 112 is fixed such that the end of the rope core 122 connected thereto is also fixed. The connection casing 132 is fixed to the suitcase bottom or rear seat or bracket, and the end of the elastic sleeve 124 connected to the connection casing 132 is thus fixed.

When the press element 114a is pressed, the press element 114 is slid with respect to the housing 112, the end of the elastic sleeve 124 connected to the press subassembly 114 is pressed to enable the elastic sleeve 124 to glide with respect to the rope core 122, but because the end of the elastic sleeve 124 connected to the connection casing 132 is fixed, the elastic sleeve 124 is bended towards one side due to the pressing, that is, a side pulling force is applied to the rope core 122 by the elastic sleeve 124, and because the end of the rope core 122 connected to the housing is fixed, the end connected to the buckle element 136 is pulled such that the buckle element 136 overcoming the spring force of the spring 134 is moved towards a direction opposite to the pressing direction of the press element 114a.

Thus, the arresting device 200 is pulled such that the arresting pin 232 is moved into the tooth recess 322 of the wheel 320 to achieve the arresting.

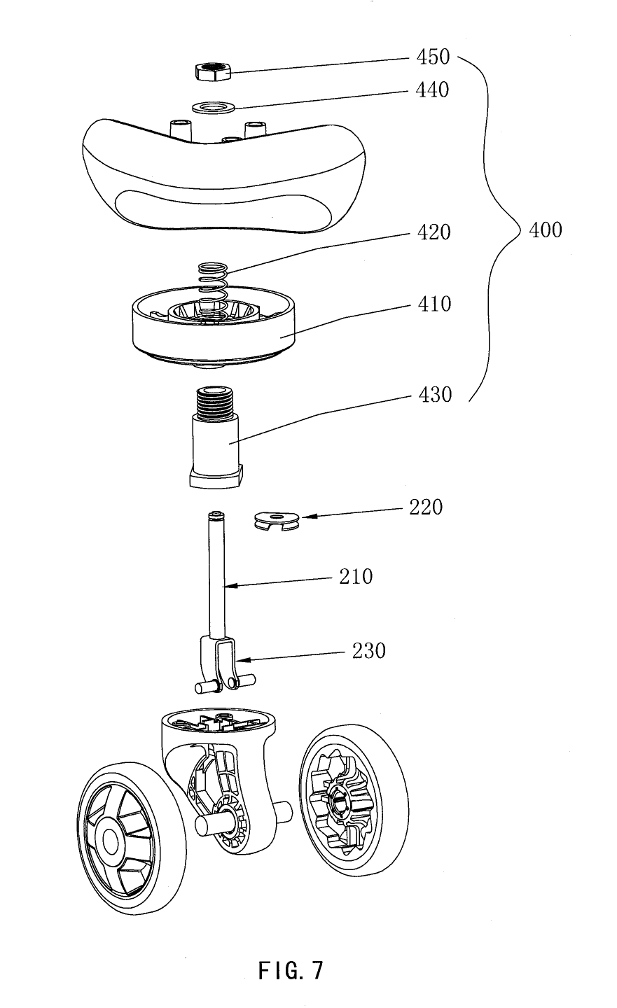

As shown in FIG. 7, a return assembly 400 is further provided between the wheel assembly 300 and the arresting device 200. The return assembly 400 comprises a connection seat 410, a return spring 420, a retaining element 430, a position limiting piece 440 and a position limiting nut 450. The connection seat 410 is fixed to the bracket 310, the retaining element 430 is mounted on the connection seat 410, and the return spring 420 is set in the retaining element 430. The driving lever 210 extends through the retaining element 430 to buckle with the buckle element 136, and an end of the return spring 420 leans against the retaining element 430, and the other end leans against the arresting element 230. The end of the retaining element 430 against which the return spring 420 leans is provided with a male thread which is adapted to connect with the position limiting piece 440 and the position limiting nut 450.

When the arresting element 230 is pulled, it should overcome the spring force of the return spring 420. If the pressure on the press subassembly 114 is released, the arresting element 230 is reset by the return spring 420 such that the arresting pin 232 is disengaged with the tooth recess 322, and the wheel 320 can be rotated again.

The return assembly 400 may be used in the structure for arresting the single wheel as well.

It should be emphasized that the above-described embodiments of the present invention, particularly, any preferred embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. An arresting assembly for a suitcase, comprising:
an arresting device connected to a wheel of the suitcase; and
a driving device connected to the arresting device, the driving device comprising:
a press and pull assembly comprising a housing and a press subassembly;
a transmission and buckle assembly comprising a connection casing, a buckle element and a spring both mounted in the connection casing, with the spring being between the buckle element and an inner wall of the connection casing, and the buckle element being connected with the arresting device; and
a pulling rope comprising a rope core and an elastic sleeve slidably covering around the rope core, the rope core being longer than the elastic sleeve in length, both ends of the rope core being respectively connected to an inner wall of the housing and the buckle element, both ends of the elastic sleeve being respectively connected to the press subassembly and the connection casing.

2. The arresting assembly of claim 1, wherein the arresting device comprises a driving lever, a connection element and an arresting element, two ends of the driving lever are connected with the connection element and the arresting element respectively, and the driving lever is connected to the buckle element via the connection element.

3. The arresting assembly of claim 2, wherein the wheel is a single wheel, the arresting element is a U-shaped member, the U-shaped member has an opening with a width larger than the axial width of the wheel, and a pair of arresting pins towards each other is arranged at the inner wall of the opening.

4. The arresting assembly of claim 2, wherein the wheel is a double wheel, the arresting element is a U-shaped member, the U-shaped member has an opening with an outer wall on which a pair of arresting pins is mounted oppositely.

5. The arresting assembly of claim 3, wherein the arresting pin has a threaded end for connecting with a corresponding threaded hole on the arresting element.

6. The arresting assembly of claim 3, wherein the arresting pin is riveted to the arresting element.

7. The arresting assembly of claim 1, wherein both ends of the rope core are provided with a clamping head, and a clamping slot for cooperating with the clamping head is provided on the inner wall of the housing and on the buckle element.

8. The arresting assembly of claim 7, wherein both ends of the elastic sleeve are provided with an end tightening casing.

9. A suitcase, comprising:
a suitcase body;
a pull rod having an outer pipe and mounted on a rear side of the suitcase body; and
the arresting assembly of claim 1;
wherein the driving device is mounted in the outer pipe and leans against components in the outer pipe, and the arresting device and the wheel are cooperatively mounted on the suitcase body.
